(19) United States
(12) Patent Application Publication
(10) Pub. No.: US 2026/0217145 A1
(43) Pub. Date: Jul. 30, 2026

(54) SINGLE-STAGE BIDIRECTIONAL ON-BOARD CHARGING MODULE

(71) Applicant: GM GLOBAL TECHNOLOGY OPERATIONS LLC, Detroit, MI (US)

(72) Inventors: Mohamed KAMEL, Birmingham, MI (US); Chandra S. Namuduri, Troy, MI (US); Rashmi Prasad, Troy, MI (US)

(21) Appl. No.: 19/041,599

(22) Filed: Jan. 30, 2025

(51) Int. Cl. B60L 53/22; H02J 7/00; H02J 7/02

(52) U.S. Cl. CPC B60L 53/22; H02J 7/02; H02J 7/60; B60L 2210/20; B60L 2210/30; H02J 2105/37; H02J 2207/20

(57) ABSTRACT

An onboard charging module includes a filter connected to a first conductor and a second conductor. The first and second conductors are connected to a voltage source. An alternating current (AC)/AC converter includes first and second sets of switches connected in between the first conductor and the second conductor. The first set of switches and the second set of switches selectively enable bidirectional current flow interruption and bipolar voltage blocking. An isolation circuit includes first terminals connected to a first node between the first set of switches and a second node between the second set of switches and second terminals connected to a third conductor and a fourth conductor. An AC/DC converter is connected to the third conductor and the fourth conductor. A filter is connected to the third conductor and the fourth conductor between the AC/DC converter and a battery.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery systems, and more particularly to a battery system for vehicles including a single-stage bidirectional on-board charging module.

Vehicles such as battery electric vehicles (BEVs), hybrid vehicles, and fuel cell vehicles include rechargeable energy storage systems (RESS). The RESS includes a battery module or pack including a plurality of battery cells. The RESS is recharged from a grid and/or may supply power from the battery module or pack to the grid (V2G).

### SUMMARY

An onboard charging module for a vehicle including a filter connected to a first conductor and a second conductor, wherein the first and second conductors are connected to a voltage source. An alternating current (AC)/AC converter includes a first set of switches connected between the first conductor and the second conductor and a second set of switches connected between the first conductor and the second conductor. The first set of switches and the second set of switches selectively enable bidirectional current flow interruption and bipolar voltage blocking. An isolation circuit includes first terminals connected to a first node between the first set of switches and a second node between the second set of switches and second terminals connected to a third conductor and a fourth conductor. An AC/direct current (DC) converter is connected to the third conductor and the fourth conductor. A filter is connected to the third conductor and the fourth conductor between the AC/DC converter and a battery.

In other features, switches of the first set of switches and the second set of switches provide bidirectional current flow interruption and bipolar voltage blocking. The first set of switches and the second set of switches are monolithically integrated. Switches of the first set of switches and the second set of switches provide unidirectional current flow interruption and unipolar voltage blocking. A voltage absorption circuit connected in parallel to the first set of switches.

In other features, a power conversion circuit is connected to the third conductor and the fourth conductor between the AC/DC converter and the battery. The power conversion circuit is configured to filter a dominant harmonic frequency.

In other features, the AC/AC converter includes a first AC/AC converter including the first set of switches and the second set of switches and a second AC/AC converter including a third set of switches connected in series between the first conductor and the second conductor and a fourth set of switches connected in series between the first conductor and the second conductor. The isolation circuit includes a first isolation circuit connected to the first node and the second node and a second isolation circuit including third terminals connected to a third node between the third set of switches and a fourth node between the fourth set of switches of the AC/AC converter and fourth terminals connected to a fifth conductor and a sixth conductor.

In other features, a controller is configured to control the first AC/AC converter using a different clock than the second AC/AC converter. The AC/AC converter includes a first AC/DC converter connected to the third conductor and the fourth conductor and a second AC/DC converter connected to the fifth conductor and the sixth conductor.

In other features, the AC/AC converter is connected to the third conductor, the fourth conductor is connected to the fifth conductor, and the AC/AC converter is connected to the sixth conductor.

In other features, a configuration changing circuit is connected to the third conductor, the fourth conductor, the fifth conductor, and the sixth conductor to selectively switch between a serial configuration and a parallel configuration.

In other features, the switches of the first set of switches and the second set of switches are made of a material selected from a group consisting of silicon (Si), silicon carbide (SiC), gallium nitride (GaN), diamond, gallium oxide (GaO), and aluminum nitride (AlN). The switches of the first set of switches and the second set of switches are selected from a group consisting of insulated gate bipolar transistors (IGBTs), metal oxide semiconductor filed effect transistors (MOSFETs), gallium nitride (GaN) high electron mobility transistors (HEMTs), and junction field-effect transistors (JFETs). The switches of the first set of switches and the second set of switches include monolithic bidirectional switches selected from a group consisting of lateral GaN on silicon (Si) and GaN on sapphire with common drain terminals and dual gates. The switches of the first set of switches and the second set of switches include monolithic bidirectional switches having common source terminals and single gate terminals. The switches of the first set of switches and the second set of switches include bidirectional bipolar junction transistors (B-TRANs).

In other features, the isolation circuit includes a transformer including a first winding having a first end connected to the first node and a second end connected to the second node and a second winding including a first end connected to the third conductor and a second end connected to the fourth conductor.

In other features, a controller is configured to control the first set of switches and the second set of switches of the AC/AC converter to adjust a phase angle of an alternating current supplied by the voltage source relative to a phase angle of an alternating voltage supplied by the voltage source.

An onboard charging module for a vehicle includes a filter connected to a first conductor and a second conductor. The first and second conductors are connected to a voltage source. An alternating current (AC)/AC converter includes a first set of switches connected in series between the first conductor and the second conductor and a second set of switches connected in series between the first conductor and the second conductor. An isolation circuit includes first terminals connected to a first node between the first set of switches and a second node between the second set of switches and second terminals connected to a third conductor and a fourth conductor. An AC/direct current (DC) converter is connected to the third conductor and the fourth conductor. A filter is connected to the third conductor and the fourth conductor between the AC/DC converter and a battery. Each switch of the first set of switches and the second set of switches provides bidirectional current flow interruption and bipolar voltage blocking. At least two switches of the first set of switches include connected source terminals and at least two switches of the second set of switches include connected source terminals.

An onboard charging module for a vehicle includes a filter connected to a first conductor and a second conductor, wherein the first and second conductors are connected to a voltage source. An alternating current (AC)/AC converter includes a first set of switches connected in series between the first conductor and the second conductor and a second set of switches connected in series between the first conductor and the second conductor. An isolation circuit includes first terminals connected to a first node between the first set of switches and a second node between the second set of switches and second terminals connected to a third conductor and a fourth conductor. An AC/direct current (DC) converter is connected to the third conductor and the fourth conductor. A filter is connected to the third conductor and the fourth conductor between the AC/DC converter and a battery. The first set of switches and the second set of switches provides bidirectional current flow interruption and bipolar voltage blocking. A controller is configured to control the first set of switches and the second set of switches of the AC/AC converter to adjust a phase angle of an alternating current supplied by the voltage source relative to a phase of an alternating voltage supplied by the voltage source.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of an on-board battery charging module;

FIG. 2 is a functional block diagram of an example of an on-board battery charging module according to the present disclosure;

FIG. 3 is an electrical schematic of an example of bidirectional switches in an alternating current (AC)/AC converter according to the present disclosure;

FIGS. 4A to 4C are electrical schematics of examples of bidirectional switches according to the present disclosure;

FIGS. 5A to 5C are electrical schematics of other examples of bidirectional switches according to the present disclosure;

FIG. 6 is an electrical schematic of an example of an on-board charging module according to the present disclosure;

FIGS. 7A to 7D are graphs illustrating line current, phase voltage, power, and transformer voltage for the on-board charging module of FIG. 6 according to the present disclosure;

FIG. 8 is an electrical schematic of an example of an on-board charging module including parallel AC/AC converters, separate transformers, and parallel rectifiers according to the present disclosure;

FIG. 9 is an electrical schematic of an example of an on-board charging module including parallel AC/AC converters, series-connected transformer outputs, and a single rectifier according to the present disclosure;

FIG. 10 is an electrical schematic of an example of an on-board charging module with parallel AC/AC converters and a series/parallel configuration changing circuit according to the present disclosure; and

FIG. 11 is an electrical schematic of an example of a circuit for filtering out dominant harmonic frequency content of the input electrical signal according to the present disclosure.

In the drawings, reference numbers may be reused to identify similar and/or identical elements.

### DETAILED DESCRIPTION

While the present disclosure describes an on-board charging module for a vehicle, the on-board charging module can be used in other mobile or stationary applications.

Some on-board battery charging modules (OBCMs) require a significant number of stages, which lowers efficiency. One of the stages includes a power factor control (PFC) circuit including a bulk capacitor having a large size/volume. The present disclosure relates to an on-board battery charging module with fewer stages and without a separate PFC circuit or the bulk capacitor in the PFC circuit. The on-board battery charging module includes switches supporting bidirectional current flow and bipolar voltage blocking capability.

In some examples, the on-board battery charging module includes a single-stage alternating current (AC)/direct current (DC) converter configuration. The AC/DC converter includes a plurality of controllable switches capable of bidirectional current flow interruption and bipolar voltage blocking capability. In some examples, the plurality of controllable switches are monolithically integrated in the same package. In some examples, the plurality of controllable switches are capable of interrupting current in one direction with a unipolar voltage blocking capability.

In some examples, the plurality of controllable switches are connected in parallel with voltage absorption circuits configured to absorb voltage overshoot. In some examples, the output port of the on-board battery charging module is connected to a power conversion system to filter out dominant harmonic frequency content of the input electrical signal.

In some examples, at least one port of the on-board battery charging module drives a transformer winding. In some examples, the on-board battery charging module drives a plurality of transformer windings connected in series. In some examples, a plurality of ports are connected in parallel or in series, where each port drives a transformer winding.

The single stage power conversion has improved overall efficiency and eliminates the PFC bulk capacitor. The reduced number of components reduces cost and volume of the on-board battery charging module. The on-board battery charging module enables higher power density, improved reliability, and is inherently bidirectional.

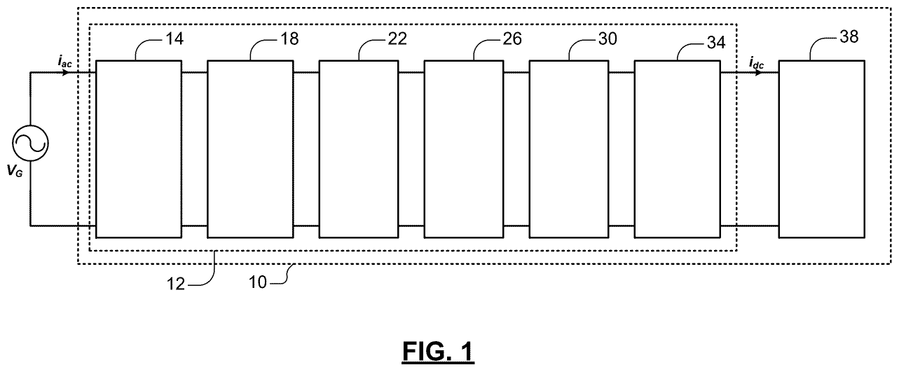

Referring now to FIG. 1, an on-board battery charging module (OBCM) 12 for a vehicle 10 including an electric propulsion motor (not shown) includes a filter 14 such as a passive or active filter that is connected to a grid supply alternating current (AC) voltage (V_{G}). A rectifier and power factor control (PFC) circuit 18 performs AC to direct current (DC) conversion and PFC. A DC/AC converter 22 receives an output of the rectifier and PFC circuit 18. An isolation barrier 26 (such as one or more transformers) is arranged between the DC/AC converter 22 and an AC/DC converter 30. A filter 34 is arranged between the AC/DC converter 30 and a load 38 such as a battery module or pack. The OBCM 12 has multiple stages since AC/DC rectification is performed more than once.

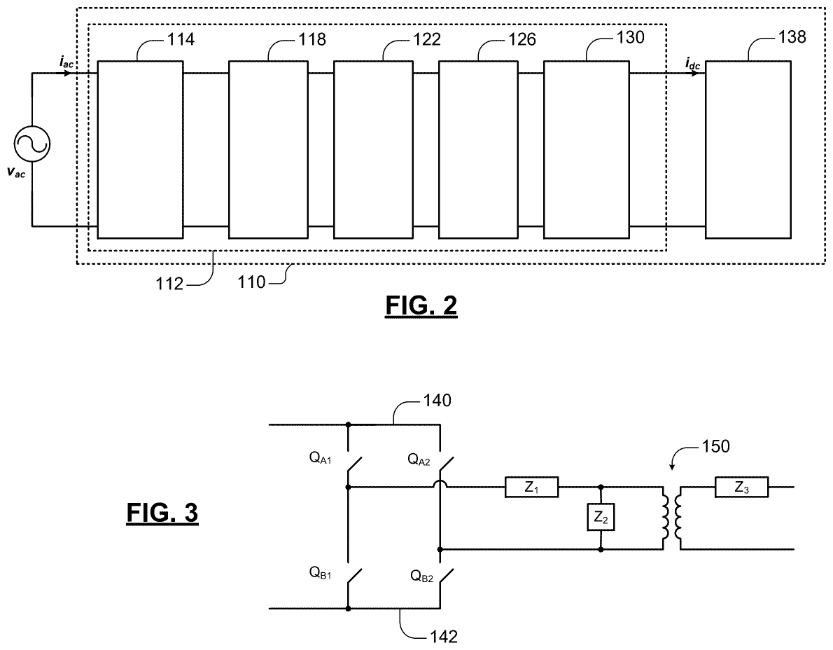

Referring now to FIG. 2, an on-board battery charging module 112 for a vehicle 110 including an electric propulsion motor (not shown) includes a filter 114 such as a passive or active filter that is connected to a grid supply alternating current (AC) voltage (V_{G}). An AC/AC converter 118 converts a frequency of the AC voltage to another frequency. An isolation circuit 122 (such as one or more transformers) is arranged between the AC/AC converter 118 and an AC/DC converter 126 performing rectification. A filter 130 is arranged between the AC/DC converter 126 and a load 138 such as a battery module or pack. The OBCM 12 a single stage since AC/DC rectification is performed once.

Referring now to FIG. 3, the AC/AC converter 118 of the on-board battery charging module includes bidirectional switches Q_{A1} and Q_{B1} and Q_{A2} and Q_{B2}. The bidirectional switches Q_{A1} and Q_{B1} (and bidirectional switches Q_{A2} and Q_{B2}) are connected in series between conductors 140 and 142. A node between the bidirectional switches Q_{A1} and Q_{B1} is connected to a first terminal of an impedance Z₁. The impedance Z₁ is connected to a first terminal of an impedance Z₂ and a first end of a first winding of a transformer 150. A node between the bidirectional switches Q_{A2} and Q_{B2} is connected to a second terminal of the impedance Z₂ and to second end of the first winding of the transformer 150. A first end of a second winding of the transformer 150 is connected to a first terminal of an impedance Z₃.

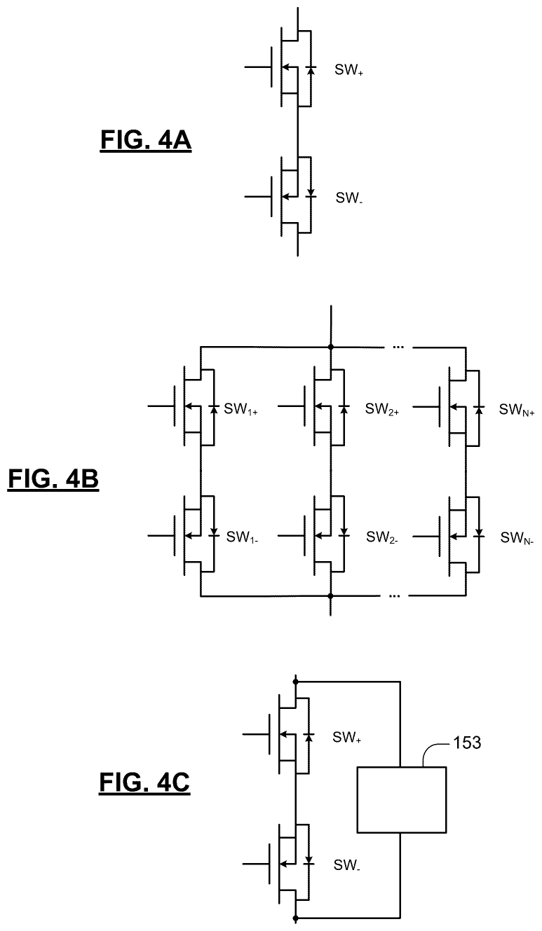

In FIGS. 4A to 4C, examples of bidirectional switches are shown. Each of the switches Q_{A1}, Q_{A2}, Q_{B1}, and Q_{B2} can include one or more switches connected in series or parallel to support bidirectional operation and/or anticipated current loads. In FIG. 4A, the switches Q_{A1}, Q_{A2}, Q_{B1}, and Q_{B2} include first and second switches SW₊and SW₋ that are connected in series. A source of the switch SW₊is connected to a source of the switch SW₋. The switches SW₊ and SW₋ include a body diode including an anode connected to the source of the switches SW₊ and SW₋ and a cathode connected to a drain of the switches SW₊and SW₋. In some examples, the first and second switches SW₊ and SW₋ are inverted relative to each other with sources connected together.

In FIG. 4B, N sets of the bidirectional switches in FIG. 4A (e.g., switches SW₁₊and SW₁₋, switches SW₂₊ and SW₂₋, . . . , and switches SW_{N+}and SW_{N-}) are connected in parallel to enable higher power applications with higher current amplitudes, where N is an integer greater than one. In FIG. 4C, a voltage absorbing circuit 153 such as a voltage clamp can be connected across the switches and used to absorb voltage overshoot. In some examples, the voltage absorbing circuit 153 includes a voltage clamp or a Zener diode.

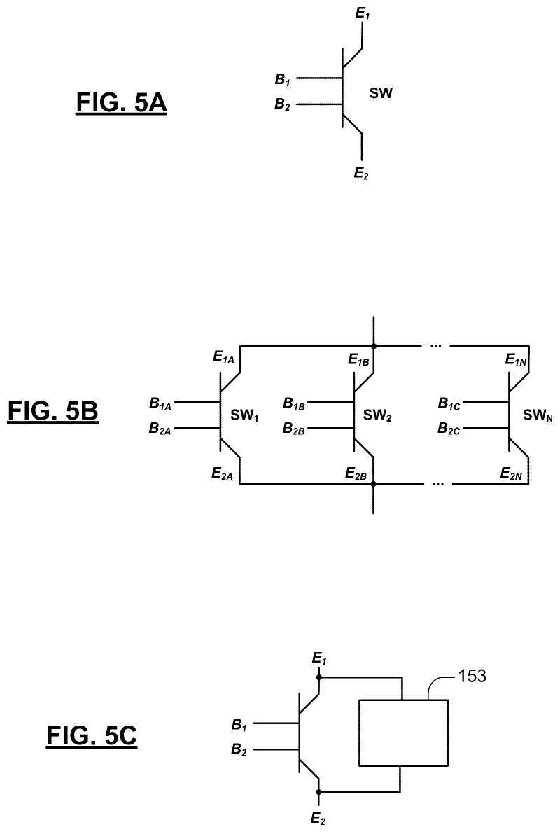

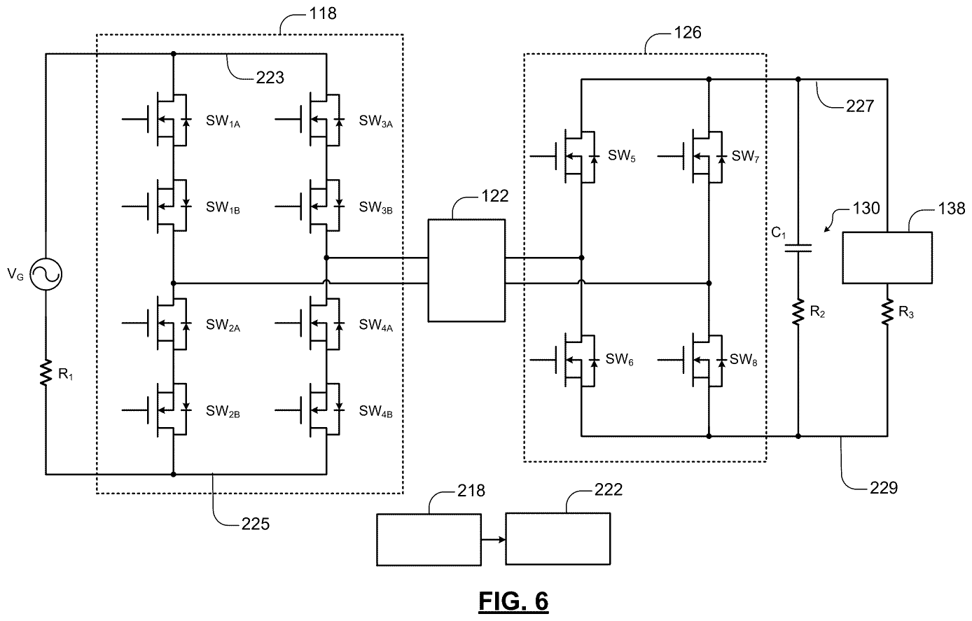

In FIG. 5A, a switch SW such as a bidirectional bipolar junction transistor (B-TRAN) includes multiple gate terminals (B₁ and B₂) that are used to control power flow in both directions. In FIG. 5B, N of the bidirectional switches (e.g., switch SW₁, switch SW₂, . . . , and SW_{N} including gate terminals B_{1A} and B_{2A}, B_{1B} and B_{2B}, . . . , and B_{1N} and B_{2N}) are connected in parallel to enable higher power applications with higher current amplitudes. In FIG. 5C, the voltage absorbing circuit 153 can be used to absorb voltage overshoot as described above.

In some examples, the bidirectional switches are made of silicon (Si), silicon carbide (SiC), gallium nitride (GaN), diamond, gallium oxide (GaO), aluminum nitride (AlN), or other wide band gap or ultra-wide band gap semiconductors with suitable voltage and current ratings.

In some examples, the bidirectional switches are selected from a group consisting of insulated gate bipolar transistors (IGBTs), metal oxide semiconductor filed effect transistors (MOSFETs), gallium nitride (GaN) high electron mobility transistors (HEMTs), or junction field-effect transistors (JFETs) with lateral, vertical, or cascode structures. In some examples, the bidirectional switches include monolithic bidirectional switches selected from a group consisting of lateral GaN on silicon (Si) or GaN on sapphire with common drain terminals and dual gates.

In some examples, the bidirectional switches include monolithic bidirectional switches having common source terminals and single gate terminals. In some examples, the bidirectional switches include monolithic bidirectional switches including bidirectional bipolar junction transistors (B-TRANs).

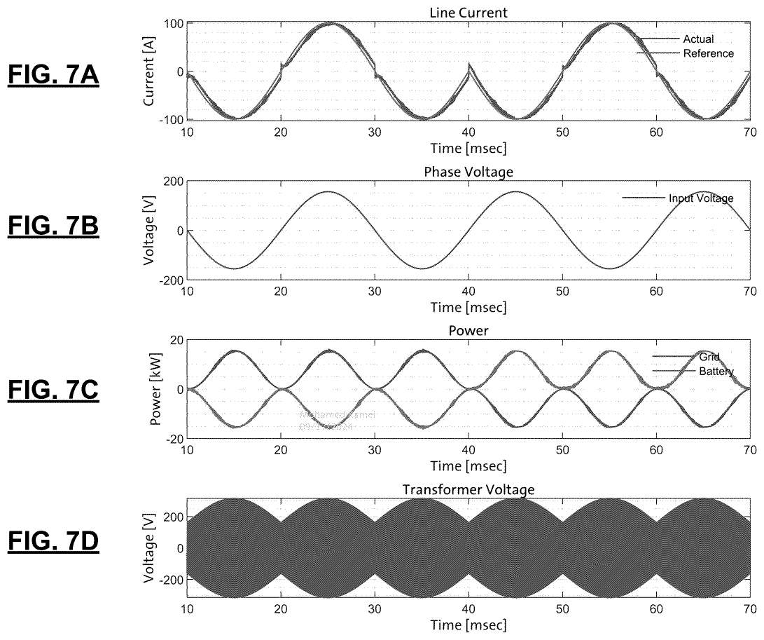

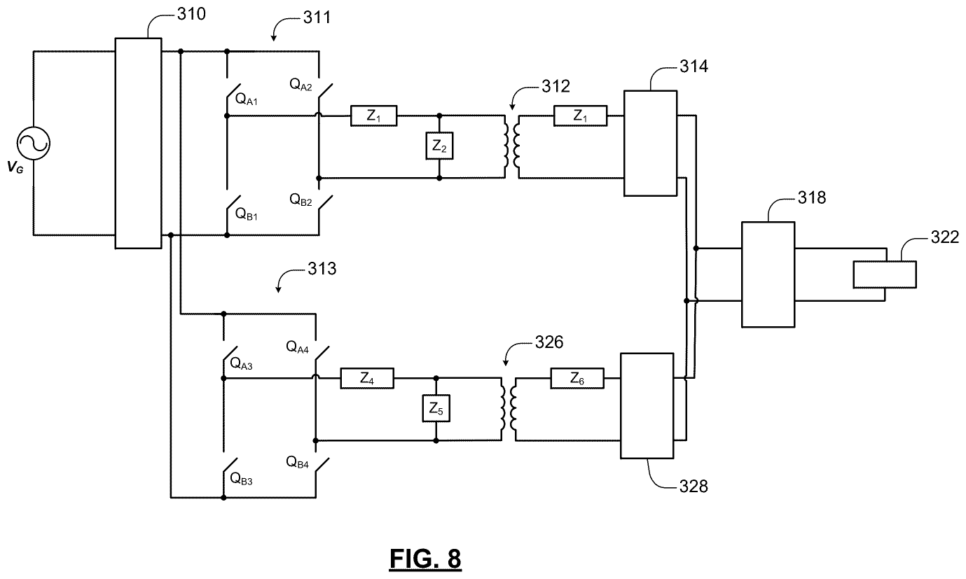

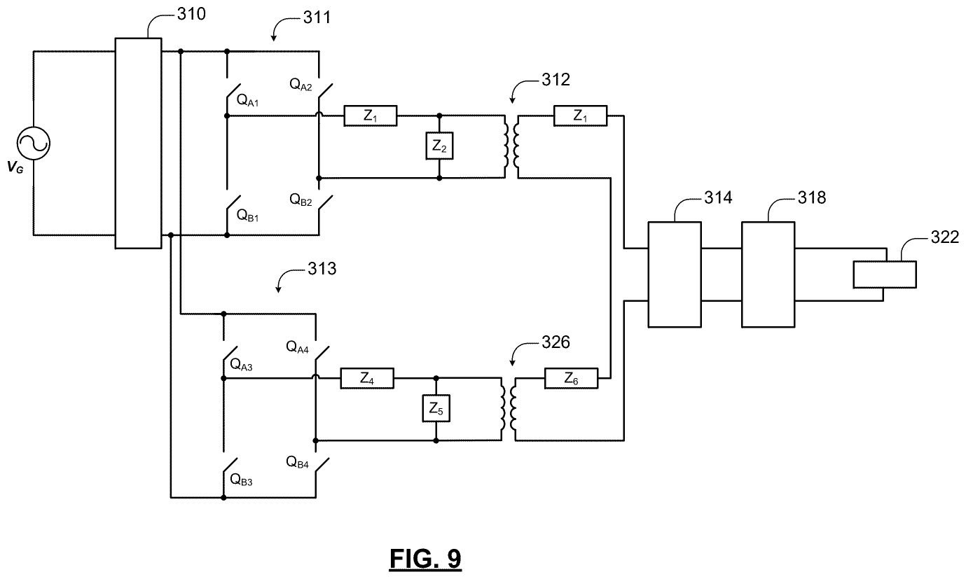

Referring now to FIGS. 6 to 7D, an example of an on-board charging module is shown. A controller 218 is configured to supply signals to control terminals of bidirectional switches 222 (e.g., switches SW_{1A}, SW_{1B}, SW_{2A}, SW_{2B}, SW_{3A}, SW_{3B}, SW_{4A}, and SW_{4B} of the AC/AC converter 118 and switches SW₅, SW₆, SW₇, and SW₈ of the AC/DC converter 126, respectively) connected between conductors 223 and 225 or conductors 227 and 229.

A first node between the bidirectional switches SW_{1A}, SW_{1B} and SW_{2A}, SW_{2B} and a second node between the bidirectional switches SW_{3A}, SW_{3B} and SW_{4A}, SW_{4B} of the AC/AC converter 118 are connected to the isolation circuit 122. The isolation circuit 122 is connected to a third node between switches SW₅ and SW₆ and a third node between switches SW₇ and SW₈ of the AC/DC converter 126. The filter 130 is shown to include a capacitor C1 and a resistor R₂. A resistor R₃ is shown connected between the battery 138 and the conductor 229.

In FIGS. 7A to 7D, graphs illustrate line current, phase voltage, power, and transformer voltage for the on-board charging module of FIG. 7. The line current and phase voltage are in phase. In some examples, a frequency of the output power is twice the frequency of the line current and phase voltage.

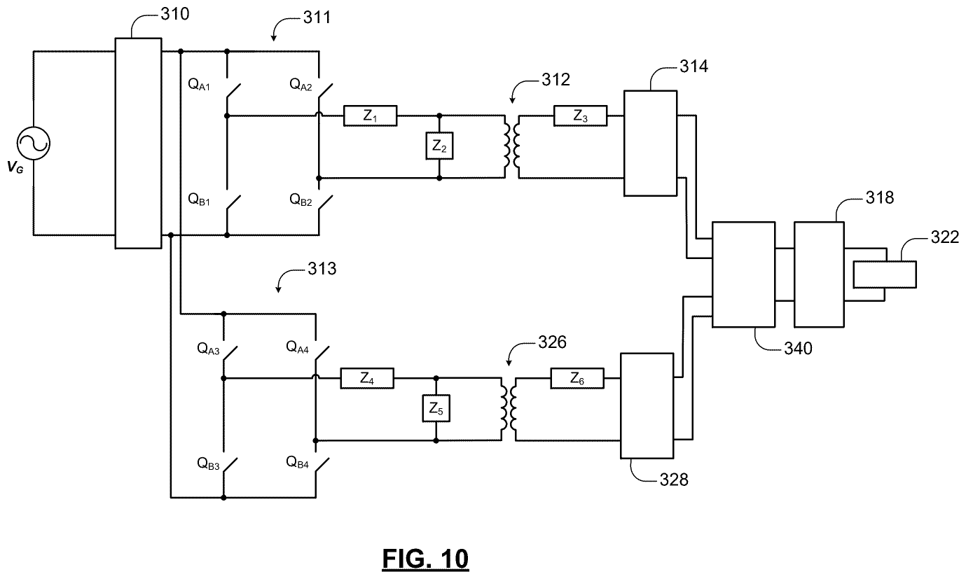

Referring now to FIG. 8, the OBCM including bidirectional switches can have different topologies. In FIG. 8, an on-board charging module including separate AC/AC converters, separate transformers, and parallel rectifiers (or AC/DC converters) is shown. An output of a filter 310 is connected in parallel to the AC/AC converter. The AC/AC converter includes a first AC/AC converter 311 and a second AC/AC converter 313 each including sets of bidirectional switches (e.g., Q_{A1} and Q_{B1} and Q_{A2} and Q_{B2}; and Q_{A3} and Q_{B4} and Q_{A4} and Q_{B4}, respectively). Outputs of the first AC/AC converter 311 (including the set of bidirectional switches Q_{A1} and Q_{B1} and Q_{A2} and Q_{B2}) is input to a first isolation circuit 312 and a first AC/DC converter 314. Outputs of the second AC/AC converter 313 (e.g., the set of bidirectional switches Q_{A3} and Q_{B4} and Q_{A4} and Q_{B4}) is input to a second isolation circuit 326 and a second AC/DC converter 328. Outputs of the first AC/DC converter 314 and the second AC/DC converter 328 are connected together in parallel to inputs of a filter 318. An output of the filter 318 is input to a battery 322. The controller 218 (FIG. 6) control the first and second AC/AC converters and/or the first and second AC/DC converters using the same clock or a different clock to provide interleaving.

Referring now to FIG. 9, an on-board charging module including series-connected transformer outputs and a single rectifier (or AC/DC converter) is shown. An output of the filter 310 is connected in parallel to the first AC/AC converter 311 and the second AC/AC converter 313. Outputs of the first AC/AC converter 311 are input to the first isolation circuit 312. Outputs of the second AC/AC converter 313 are input to the second isolation circuit 326.

Outputs of the first isolation circuit 317 and the second isolation circuit 326 are connected in series to the first AC/DC converter 314. In other words, a first output of the first isolation circuit 312 is input to the first AC/DC converter 314. A second output of the first isolation circuit 312 is connected to a first output of the second isolation circuit 326. A second output of the second isolation circuit 326 is input to the first AC/DC converter 314. An output of the first AC/DC converter 314 is input to the filter 318. An output of the filter 318 is input to the battery 322. The configuration shown in FIG. 9 is configured to output higher voltages using a single high voltage (HV) rectifier (or AC/DC converter). The controller 218 (FIG. 6) control the first and second AC/AC converters and/or the first and second AC/DC converters using the same clock or a different clock to provide interleaving.

Referring now to FIG. 10, an on-board charging module with a series/parallel reconfigurable output is shown. An output of a filter 310 is connected in parallel to the sets of bidirectional switches Q_{A1} and Q_{B1} and Q_{A2} and Q_{B2} and bidirectional switches Q_{A3} and Q_{B4} and Q_{A4} and Q_{B4} as shown above. Outputs of the set of bidirectional switches Q_{A1} and Q_{B1} and Q_{A2} and Q_{B2} are input to the first isolation circuit 312 and a first AC/DC converter 314. Outputs of the set of bidirectional switches Q_{A3} and Q_{B4} and Q_{A4} and Q_{B4} are input to the second isolation circuit 326 and a second AC/DC converter 328. Outputs of the first AC/DC converter 314 and the second AC/DC converter 328 are connected to a serial/parallel configuration changing circuit 340 configured to switch between parallel and serial configurations. For example, the serial/parallel configuration changing circuit 340 can include an array of switches to selectively change the configuration from series (e.g., FIG. 8) to parallel (e.g., FIG. 7) or vice versa. Outputs of the serial/parallel configuration changing circuit 340 are input to the filter 318. An output of the filter 318 is input to the battery 322. The controller 218 (FIG. 6) control the first and second AC/AC converters and/or the first and second AC/DC converters using the same clock or a different clock to provide interleaving.

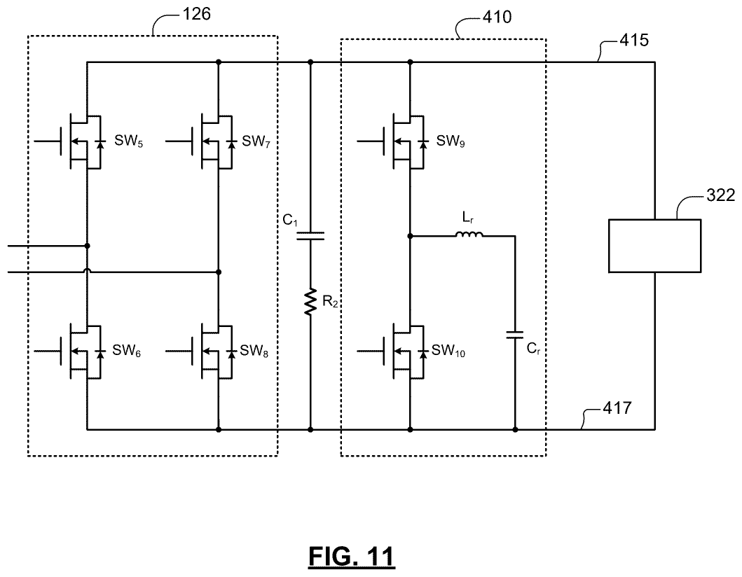

Referring now to FIG. 11, a power conversion system 410 is arranged between the AC/DC converter 126 and the battery 322. The power conversion system 410 includes switches SW₉ and SW₁₀ arranged between conductors 415 and 417. A first terminal of an inductor Lᵣ is connected to a node between the switches SW₉ and SW₁₀. A second terminal of the inductor Lᵣ is connected to a first terminal of a capacitor Cᵣ. A second terminal of the capacitor Cᵣ is connected to the conductor 417. The power conversion system 410 filters out dominant harmonic frequency content of the input electrical signal.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML 5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. An onboard charging module for a vehicle, comprising:
a filter connected to a first conductor and a second conductor, wherein the first and second conductors are connected to a voltage source;
an alternating current (AC)/AC converter including a first set of switches connected between the first conductor and the second conductor and a second set of switches connected between the first conductor and the second conductor, wherein the first set of switches and the second set of switches selectively enable bidirectional current flow interruption and bipolar voltage blocking;
an isolation circuit including first terminals connected to a first node between the first set of switches and a second node between the second set of switches and second terminals connected to a third conductor and a fourth conductor;
an AC/direct current (DC) converter connected to the third conductor and the fourth conductor; and
a filter connected to the third conductor and the fourth conductor between the AC/DC converter and a battery.

2. The onboard charging module of claim 1, wherein switches of the first set of switches and the second set of switches provide bidirectional current flow interruption and bipolar voltage blocking.

3. The onboard charging module of claim 1, wherein the first set of switches and the second set of switches are monolithically integrated.

4. The onboard charging module of claim 1, wherein switches of the first set of switches and the second set of switches provide unidirectional current flow interruption and unipolar voltage blocking.

5. The onboard charging module of claim 1, further comprising a voltage absorption circuit connected in parallel to the first set of switches.

6. The onboard charging module of claim 1, further comprising a power conversion circuit connected to the third conductor and the fourth conductor between the AC/DC converter and the battery, wherein the power conversion circuit is configured to filter a dominant harmonic frequency.

7. The onboard charging module of claim 1, wherein:
the AC/AC converter includes a first AC/AC converter including the first set of switches and the second set of switches and a second AC/AC converter including a third set of switches connected in series between the first conductor and the second conductor and a fourth set of switches connected in series between the first conductor and the second conductor, and
the isolation circuit includes:
a first isolation circuit connected to the first node and the second node; and
a second isolation circuit including third terminals connected to a third node between the third set of switches and a fourth node between the fourth set of switches of the AC/AC converter and fourth terminals connected to a fifth conductor and a sixth conductor.

8. The onboard charging module of claim 7, further comprising a controller configured to control the first AC/AC converter using a different clock than the second AC/AC converter.

9. The onboard charging module of claim 7, wherein the AC/AC converter includes a first AC/DC converter connected to the third conductor and the fourth conductor and a second AC/DC converter connected to the fifth conductor and the sixth conductor.

10. The onboard charging module of claim 7, wherein:
the AC/AC converter is connected to the third conductor;
the fourth conductor is connected to the fifth conductor; and
the AC/AC converter is connected to the sixth conductor.

11. The onboard charging module of claim 9, further comprising a configuration changing circuit connected to the third conductor, the fourth conductor, the fifth conductor, and the sixth conductor to selectively switch between a serial configuration and a parallel configuration.

12. The onboard charging module of claim 1, wherein the switches of the first set of switches and the second set of switches are made of a material selected from a group consisting of silicon (Si), silicon carbide (SiC), gallium nitride (GaN), diamond, gallium oxide (GaO), and aluminum nitride (AlN).

13. The onboard charging module of claim 1, wherein the switches of the first set of switches and the second set of switches are selected from a group consisting of insulated gate bipolar transistors (IGBTs), metal oxide semiconductor filed effect transistors (MOSFETs), gallium nitride (GaN) high electron mobility transistors (HEMTs), and junction field-effect transistors (JFETs).

14. The onboard charging module of claim 1, wherein the switches of the first set of switches and the second set of switches include monolithic bidirectional switches selected from a group consisting of lateral GaN on silicon (Si) and GaN on sapphire with common drain terminals and dual gates.

15. The onboard charging module of claim 1, wherein the switches of the first set of switches and the second set of switches include monolithic bidirectional switches having common source terminals and single gate terminals.

16. The onboard charging module of claim 1, wherein the switches of the first set of switches and the second set of switches include bidirectional bipolar junction transistors (B-TRANs).

17. The onboard charging module of claim 1, wherein the isolation circuit includes a transformer including a first winding having a first end connected to the first node and a second end connected to the second node and a second winding including a first end connected to the third conductor and a second end connected to the fourth conductor.

18. The onboard charging module of claim 1, further comprising a controller configured to control the first set of switches and the second set of switches of the AC/AC converter to adjust a phase angle of an alternating current supplied by the voltage source relative to a phase angle of an alternating voltage supplied by the voltage source.

19. An onboard charging module for a vehicle, comprising:
a filter connected to a first conductor and a second conductor, wherein the first and second conductors are connected to a voltage source;
an alternating current (AC)/AC converter including a first set of switches connected in series between the first conductor and the second conductor and a second set of switches connected in series between the first conductor and the second conductor;
an isolation circuit including first terminals connected to a first node between the first set of switches and a second node between the second set of switches and second terminals connected to a third conductor and a fourth conductor;
an AC/direct current (DC) converter connected to the third conductor and the fourth conductor; and
a filter connected to the third conductor and the fourth conductor between the AC/DC converter and a battery,
wherein each switch of the first set of switches and the second set of switches provides bidirectional current flow interruption and bipolar voltage blocking, and
at least two switches of the first set of switches include connected source terminals and at least two switches of the second set of switches include connected source terminals.

20. An onboard charging module for a vehicle, comprising:
a filter connected to a first conductor and a second conductor, wherein the first and second conductors are connected to a voltage source;
an alternating current (AC)/AC converter including a first set of switches connected in series between the first conductor and the second conductor and a second set of switches connected in series between the first conductor and the second conductor, wherein the first set of switches and the second set of switches provides bidirectional current flow interruption and bipolar voltage blocking;
an isolation circuit including first terminals connected to a first node between the first set of switches and a second node between the second set of switches and second terminals connected to a third conductor and a fourth conductor;
an AC/direct current (DC) converter connected to the third conductor and the fourth conductor; and
a filter connected to the third conductor and the fourth conductor between the AC/DC converter and a battery, and
a controller configured to control the first set of switches and the second set of switches of the AC/AC converter to adjust a phase angle of an alternating current supplied by the voltage source relative to a phase of an alternating voltage supplied by the voltage source.
